(19) United States
(12) Patent Application Publication
(10) Pub. No.: US 2006/0236400 A1
(43) Pub. Date: Oct. 19, 2006

(54) Secure and auditable on-line system

(75) Inventor: Steindor S. Gudmundsson, REYKJAVIK (IS)

Correspondence Address: BIRCH STEWART KOLASCH & BIRCH, PO BOX 747, FALLS CHURCH, VA, 22040-0747, US

(73) Assignee: BETWARE A ISLANDI HF., REYKJAVIK (IS)

(21) Appl. No.: 10/563,918

(22) PCT Filed: Jul. 12, 2004
(86) PCT No.: PCT/IS04/00007

§ 371 Date: Jan. 10, 2006

Related U.S. Application Data
(60) Provisional application No. 60/485,733, filed on Jul. 10, 2003.

(30) Foreign Application Priority Data
Jul. 10, 2003 (IS) 6872

(51) Int. Cl. G06F 11/00

(52) U.S. Cl. 726/25

(57) ABSTRACT

The present invention provides a method a system and a device for obtaining security and auditability in an on-line system. The system is a closed system and only auditors and/or authorities have access to the system. By means of a random number generator and a processing means a random number—sequence number pair is generated and stored in a storage means. By verifying stored random number—sequence number pairs, every stored random number—sequence number pair can be authenticated.

### FIELD OF INVENTION

The present invention relates to generation of security and audit ability in an on-line system, such as an instant ticket lottery, a code generation system, an encryption system, or a money transfer system. More particularly, the present invention relates to secure management of an on-line system, in particular an on-line ticket lottery.

### BACKGROUND OF THE INVENTION

Modern communication networks such as the Internet, Wide Area Networks (WANs) and Local Area Networks (LANs), have proven to be enormously efficient means of organizing and distributing digital data. This has resulted in a widespread use of these networks for business, entertainment and personal applications. The Internet is now a common network for performing electronic commerce, banking and electronic mail transactions as well as being widely used for academic purposes, providing information and gaming and betting activities.

The traditional gaming and betting systems have been based on direct interaction in a common physical location, such as casinos, bingo halls, and sports betting halls and buying physical lottery tickets. The Internet, however, offers a solution for those who cannot visit the physical locations for some reason, such as hospitalised individuals, or people with impaired mobility due to a handicap, or for people living in remote areas far away from traditional gaming and betting facilities.

Ticket lottery games are popular sources of revenue for governmental bodies and step is performed at charitable organizations, being either a scratch-off or pull-tab game with a number of pre-printed tickets. A lottery ticket comprises a printed result indicator, indicating whether or not a particular ticket is a winning ticket and, if so, the nature of the winning. Several electronic lottery games have been implemented through computer-based systems. U.S. Pat. No. 5,324,035 incorporates all information required to define a game play into a video lottery system, including data for various graphic symbols to be displayed to the player through the player terminal. This arrangement results in relatively large amounts of data having to be transferred to the player terminal for each game play.

U.S. Pat. No. 4,494,197 discloses a method for wagering, which utilizes a counter register and winning ticket table situated in a central processor unit. Upon a request from a player terminal, the value in the counter register is incremented and then the winning ticket table is queried to determine if the resulting count corresponds to a winning electronic ticket. The central processor then sends back to the player terminal a packet of information including a winning or losing code as appropriate. The winning code includes the amount won on the play.

U.S. Pat. No. 4,842,278 describes the interconnection of two or more state lottery games into a national game. This lottery is a betting game wherein the winning odds are calculated based upon an input from the player throughout the entire region, and not just from a single state. Payoffs are provided according to a total amount wagered and the number of winning bettors, somewhat like a pari-mutuel system.

U.S. Pat. No. 5,158,293 describes another multiple level game, in the sense that players may be sequentially eligible for different prizes or payoffs during the course of play. However, this document makes no mention of any different wagering denominations by different groups of bettors, and resulting different pools and accordingly different prizes or payoffs. In U.S. Pat. No. 6,017,032 is disclosed a lottery game and method of play, in which provision is made for wagers at different denominational levels. Each wager of a given denominational level is placed in a sep step is performed at a rate jackpot pool, with the winner or winners paid from that pool. All wagers of all denominations pass through a central controller or agency, where they are distributed to the appropriate pool or pool fraction or portion.

The use of true random number generators (TRNG), to deliver so called true or non-deterministic random numbers are well known per se in the art. Such devices use a low-frequency oscillator and a high-frequency oscillator, and are, e.g., disclosed in U.S. Pat. No. 4,641,102; U.S. Pat. No. 5,781,458 and U.S. Pat. No. 6,061,702. In another document, methods of generating true random numbers using components normally available on personal computers, is described (US 2003037079). The method includes generating true random number sequences of calculable entropy content. The entropy is derived from a random noise component, or transition jitter, in one or both of a low- and a high-frequency signal source that are coupled to a processor for producing the random numbers. The high-frequency signal source includes a frequency multiplier that significantly increases the size of the noise component in the high-frequency signal. This will allow for rapid production of true random numbers of known, high quality.

### SUMMARY OF THE INVENTION

It is an object of the present invention to provide an on-line system, which may be managed in a secure manner.

It is a further object of the present invention to provide an on-line system, which is sufficiently secure to meet the demands of, e.g., instant ticket lotteries.

It is an even further object of the present invention to provide an on-line system having limited access in order to obtain a secure and controllable management of the system.

It is an even further object of the present invention to provide a method for managing such an on-line system in a secure manner.

It is an even further object of the present invention to provide a method for managing such an on-line system in a controllable manner.

It is an even further object of the present invention to provide a device for managing such an on-line system in a secure manner.

It is an even further object of the present invention to provide a device for managing such an on-line system in a controllable manner.

It is an even further object of the present invention to provide a method for ensuring auditing of an on-line system, where an evidence database is generated simultaneously to the generation of the ticket or a wager.

According to a first aspect of the present invention the above and other objects are obtained by providing a method of obtaining security and audit ability in an on-line system, the method comprising the steps of:
generating a random number by means of a random number generator,
providing a sequence number for each of the random numbers generated so as to create a random number—sequence number pair,
storing the created random number—sequence number pair in a storage means,
   the method further comprising the step of, at a chosen time, verifying stored random number—sequence number pairs, so as to ensure that every stored random number—sequence number pair is an authentic random number—sequence number pair.

According to a second aspect of the present invention the above and other objects are obtained by providing a secure and auditable on-line system comprising:
a random number generator,
means for providing a sequence number for each generated random number, so as to create a random number—sequence number pair,
storage means for storing the created random number—sequence number pair,
verifying means for verifying, at a chosen time, stored random number—sequence number pairs, so as to ensure that every stored random number—sequence number pair is an authentic random number—sequence number pair.

An important feature of the present invention is the audit ability, a mechanism that verifies all random number—sequence number pairs generated by the system. The random number -sequence number pairs stored in the storage means are the basis for the audit process, wherein a routine check can be made at a chosen time. By double-checking the pairs the auditors can spot if an intruder is bypassing the random number generator in order to select especially favourable sequence numbers.

In the present context the term “security” refers to techniques for ensuring that data stored in the storage means cannot be unrightfully read or tampered with in any way, such as selecting only certain data from a processing means or storage means, which are to be sequentially or randomly distributed.

In the present context the term “audit ability” refers to the ability to maintain a record for a system showing if the system has been invaded or illegally accessed and what operations were performed during a given period of time. The audit process may be set up in a way that a special audit trail means enables the administrators to monitor use of network system.

In the present context the term “on-line” refers to a communication network, such as, but not limited to the Internet, Wide Area Networks (WANs) and Local Area Networks (LANs). Further more the term “on-line” refers to any network comprising a gaming platform and a plurality of end user clients.

In the present context the term “sequence number” refers to any number being selected from an array of numbers comprising a certain amount of numbers, which have been evenly and sequentially lined up. The numbers may be selected from the group of, but not limited to 10, 100, 1.000, 10.000, 100.000, 1.000.000, 10.000.000 or 100.000.000 numbers between any two number such as, but not limited to 0 and 1.

In the present context the term “verify” refers to a process, where actions or transactions in a system are checked. The term may further refer to presence or absence of data in a system and, if the date is present, then the verifying step may refer to whether the data have been manipulated or not. The verification may be a manual or automatic process performed routinely or randomly. A random number—sequence number pair is “authentic” if the verifying step establishes that it was rightfully created and stored by the system, i.e. it has not been tampered with, and it was not stored by a party which is not entitled to create and store random number—sequence number pairs.

The storage means for storing the random number—sequence number pairs is preferably an electronic storage means, such as a hard disc drive, a CD-ROM, a DVD disc, a floppy disc, a magnetic tape, or any other suitable kind of data storage means.

The verifying step may be performed at at least substantially equal time intervals, such as once or twice every day, every second day, every week, every month, every hour, etc. In this embodiment the verifying step is performed as a routine action, where all stored random number—sequence number pairs are verified as a precaution. However, it may further be possible to perform the verifying step at a chosen time not falling within the normal time for a routine action. This may, e.g., be desirable in case there is reason to believe that some of the numbers have been tampered with, or that somebody has unrightfully gained access to the stored numbers.

In a preferred embodiment the generated random number is a true random number, and the random number generator is a true random number generator. In the present context the term “true random number generator” refers to a device that generates true random numbers, typically by sampling and processing a source of entropy outside the device. The entropy source can, e.g., be a radioactive source, atmospheric noise from a radio or lava lamps.

The storing step may be performed by storing the random number—sequence number pair in a storage means with limited access. The term “limited access” may be interpreted as meaning that only certain persons have access to the storage means. It may, e.g., be a secure enclosed system; a so-called “black box” and/or it may comprise a locked compartment.

Furthermore, the random number generator may have limited access. The storage means and the random number generator may be positioned in the same limited access area (e.g. the same “black box” or the same locked compartment) of the system. The limited access area may further comprise a sequence number generator, so that the generation of the random number, the generation of the sequence number, and the storing of the random number—sequence number pair all take place within the limited access area, thereby reducing the risk that any of the numbers may be tampered with, or that a false/unauthentic random number—sequence number pair may be stored in the storage means.

Access to the limited access area(s) may be obtained only by one or more authorised persons, such as by two or more authorised persons. Each of the two or more authorized persons may represent an authority, so that at least two authorities are represented when access to the limited access area(s) is obtained. At least one of the authorised persons may represent an operator, and at least one of the authorised persons may represent an auditor. In this embodiment, at least one person representing the operator, and at least one person representing some kind of auditing authority have to be present in order to gain access to the limited access area(s). The person representing the operator may be a person pointed out by or employed by the entity, which administers the on-line system for management and supervision of the system. The person representing the auditor may be a government official person supervising the operation of the on-line system, e.g. in order to ensure that the system fulfils certain official requirements, e.g. in order to maintain public trust in the system. An authorized person for the Betware Gaming Platform (BGP) cannot be the same person as the authorised person for the certifying area comprising the black box, the evidence data base and the auditing means.

In an embodiment of the present invention the authorised person(s) for the evidence data base, Black Box and the auditing means may be different persons each only authorized for each of the components of the certifying area. The auditing means of the present invention can be any data processor, residing in a computing means such as a PC computer.

The limited access area is further able to generate a transaction log comprising:
a timestamp,
a game-id,
a customer-id,
a prize category,
a prize amount,
a sequence number, and
a random number,
   wherein the transaction log is stored in a second limited access area. The limited access area may also comprise a prize table. The limited access area can only be obtained by one or more authorized persons and the transaction log is audited by one or more audit processes performed by audit-processing means.

In an embodiment of the present invention the information regarding the on-line ticket is stored in an evidence storage means and this information is used to audit information in the gaming system by one or more of the audit processes performed by audit processing means.

In the present context the evidence storage means is an evidence database.

In an embodiment of the present invention the first storage means further comprises means for generating a transaction log and a get list stored in a second storage means, wherein the second storage means is an evidence storage means. The data stored in the first storage means and the data stored in the evidence storage means is used as evidence to audit information in the gaming system by an audit processing means.

In an embodiment of the present invention the first storage means can be replaced by the second storage means, by means of having the driver software for the Black Box store the transaction log directly to the evidence database.

In an embodiment of the present invention the first storage means, second storage means and the audit processing means are concealed in a certifying zone. The evidence storage means can only be obtained by one or more authorized persons.

In a preferred embodiment of the present invention the security and audit ability are obtained by a closed system, wherein the secure and close system may be-a so-called “black box” unit. The “black box” may comprise the following components:
A locked box,
A random number generator,
A sequence number generator, and
Storage means

The “black box” can further be described as an environment hosting data storage means, processors and generators and the “black box” may provide a physical barrier which only authorized administrators and auditors have access to.

The method may further comprise the step of issuing a ticket comprising information relating to the sequence number. This information may be the sequence number itself. The ticket may be a token or a receipt to a user of the on-line system, and the ticket may indicate the actions performed by the system on request from the user, such as the generation of a code or an encryption or decryption key, a money transaction, or the generation of a lottery ticket. Preferably, the ticket does not comprise the generated random number. However, it may comprise information relating to the random number. Thus, in case the on-line system is a ticket lottery, the random number determines whether or not the ticket is a winning ticket, and such information may advantageously be present on the ticket. For some purposes, however, the ticket may comprise the actual random number.

In an embodiment of the present invention, an on-line ticket can be regenerated in the certifying zone without the information from the BGP.

In a preferred embodiment the on-line system is a lottery, and the issued ticket is a lottery ticket. In this case the ticket may further comprise information relating to a winning/no-winning category of the ticket. As mentioned above, this information may relate to the generated random number.

In case the on-line system is a lottery, the step of issuing a ticket may be based upon the random number and a probability table, in which case the method may further comprise the step of updating the probability table in response to the issued ticket, so as to maintain an at least substantially fixed winning/no winning ratio. Thus, the on-line ticket lottery functions as if it-was a conventional ticket lottery in which all the tickets have been created in advance. But in the on-line ticket lottery according to the present invention the tickets have not been created in advance, but are created when they are drawn, i.e. when a user requests a ticket.

In one embodiment of the present invention the on-line system is a code generation system. According to this embodiment the random number—sequence number pair represents a code for the protection of ID numbers or social security numbers In a database. The database may contain personal information on individuals such as, but not limited to health records, financial records or social records.

In another embodiment of the present invention the on-line system is an encryption system. According to this embodiment the random number—sequence number pair represents an encryption and/or a decryption key. It is a great advantage that such keys may be created, stored and used in a secure and auditable manner, since this increases the trust that the public may have in the system.

In yet another embodiment of the present invention the on-line system is a money transfer system. It may be a cash point or a system to electronically transfer money from one account to another. In this case it is ensured by the verifying step that only the right persons transfer/withdraw money from a specific account.

The method may further comprise the step of alerting an operator in case the verifying step results in the discovery of one or more non-authentic random number—sequence number pairs. The alert may be in the form of a printed report indicating that something is wrong, and that appropriate actions should therefore be taken. Alternatively or additionally, the alert may be in the form of an electronic message, e.g. an e-mail sent to an operator, or an electronic flag, or any other suitable kind of alert.

The step of generating a random number may be performed upon the request from a user. Thus, a lottery ticket, a code, an encryption/decryption key, a money transfer, etc. is created/performed on the request of a user. The user thereby initiates the operating steps of the present invention.

The method may further comprise the step of receiving payment from a user. This is particularly useful in case the on-line system is a system offering services, which the user should pay for, e.g., a ticket lottery, a code generation system or an encryption system. Preferably, the step of receiving payment is performed before the random number is generated, thereby enabling the system to make sure that appropriate payment for the service has been received before the service is provided. The payment step may, e.g., be performed by the user delivering bank notes or coins to a paying machine. Alternatively or additionally, the payment step may be performed by means of a card reader for credit cards or cash cards (smart cards). Alternatively or additionally, the payment step may be performed by means of an electronic money transfer, e.g. an account-to-account transfer, or a transfer from an electronic wallet to an account.

The verifying step may comprise checking that a certain number of random numbers has been generated. This is particularly useful when the on-line system is a ticket lottery. In this case the certain number of random numbers corresponds to the number of possible lottery tickets in the game. When all the tickets have been drawn, the game should, of course, be closed.

The verifying step may comprise the steps of:
checking whether a given random number—sequence number pair has previously been stored in the storage means,
marking said given random number—sequence number pair as a true pair in case it has previously been stored in the storage means, and
alerting an operator in case the given random number—sequence number pair has not previously been stored in the storage means.

In this embodiment it is assumed that only authentic random number—sequence number pairs have been stored in the storage means, and that all authentic random number—sequence number pairs have been stored.

According to a third aspect of the present invention the above and other objects are obtained by providing a device for obtaining security and audit ability in an on-line system, the device comprising:
a random number generator,
means for providing a sequence number for each generated random number, so as to create a random number—sequence number pair,
storage means for storing the created random number—sequence number pair,
verifying means for verifying, at a chosen time, stored random number—sequence number pairs, so as to ensure that every stored random number—sequence number pair is an authentic random number—sequence number pair,
   the verifying means further comprising:
means for checking whether a given random number—sequence number pair has previously been stored in the storage means,
means for marking said given random number—sequence number pair as a true pair in case it has previously been stored in the storage means, and
means for alerting an operator in case the given random number—sequence number pair has not previously been stored in the storage means,
   wherein the storage means and the random number generator have limited access.

According to a fourth aspect, the invention provides a computer program product for obtaining security and audit ability in an on-line system, the program being adapted to:
generate a random number by means of a random number generator,
provide a sequence number for each of the random numbers generated so as to create a random number—sequence number pair,
store the created random number—sequence number pair in a storage means,
   the program further being adapted to verify stored random number—sequence number pairs, so as to ensure that every stored random number—sequence number pair is an authentic random number—sequence number pair. The computer program may incorporate any of the features disclosed in relation to the first and second aspects of the invention.

The computer program product can further generate a transaction log comprising:
a timestamp,
a game-id,
a customer-id,
a sequence number, and
a random number,
   wherein the transaction log is stored in first or second storage means. The online generated information in a first storage means and a second storage means is used to audit info in the Gaming System external to the auditing system by one or more audit processes performed by an audit processing means.

### EXAMPLES

### Example 1

Generation of Security in an On-Line Ticket Lottery

Objectives

To reach audit ability a in an on-line ticket lottery by attachment of a secure closed system (a so-called “black box”), providing physical security for services relating to creation of the tickets. The “black box” service that is locked and can only be opened while “auditors” are present. The “black box” will offer services that can be audited.

Methods

The Audit Process (AP) is based on audit ability, and is reached by attaching a “True Random Number Generator” to a PC compatible machine in a locked box generating a true random number and a sequence number. Every time the Betware Gaming Platform (BGP) gets a request from a player it requests a true random number from the “black box”. A random number—sequence number pair is created, sent to the BGP and saved in the “black box”. The audit process goes through every instant record in the BGP database and compares the random number—sequence number pair to the contents of the “black box”.

Results

The audit ability of the system is reached by attaching a “True Random Number Generator” to a PC compatible machine in a locked box that offers two services:
Auditable True Random Number by use of a sequence number
Approving the specific TRN for a specific winning category

To reach audit ability the “black box” will return sequence number together with each random number. This sequence number will be saved with the ticket. The Approving service can then be used later to approve that the specific ticket (winning ticket) actually got a random number that resulted in a winning.

### Example 2

Generation of Audit Ability in an Instant Ticket Lottery

Objectives

To strengthen security of an on-line ticket lottery, a process has been defined that will periodically approve sold Instant Tickets according to rules specified by the lottery. The security system should be a flexible process that can be run periodically and approve a batch of tickets according the secure services of a “black box”.

Methods

Upon a request from the Betware Gaming Platform (BGP), a random number—sequence number pair is created and saved in the “black box”. A routine mechanism will start at predetermined times like once or twice every day. If the system is being manipulated by an intruder, the system will alert the administrators of the lottery. The Audit Process (AP) verifies the random number—sequence number pairs saved in a storage means also exists in the “black box” and an alert is given if something does not match, like if there are gaps in the sequence in the BGP database. The AP also recalculates each instant ticket drawn from the pool and verifies that it is according to the random number drawn. The security system can also aid in pool management of the lottery by sending messages to the BGP that all the tickets in a pool have been sold and all the random number—sequence number pairs are confirmed.

Results

One of the functions of the security mechanism is to double check at all times the correctness of the winning selection according to Lottery's pre-specified rules as well as approving that the SecureTRNG is not generating more random numbers than are used by the Instant Ticket Service. That could be the case if intruders will invade the system to get a supposed to be good “random” number and only buy tickets when he gets one. Lottery can specify the period (usually daily) and the prize categories that are checked. A default setting orders checking of all but lowest price and no winning tickets. This will allow the system to make sure that winning tickets, possibly generated by bypassing the Secure-TRNG, are spotted by the end of the day. Another function is comparison of all sequence numbers in the database against of all sequence numbers serviced by the “black box” to avoid the possibility that a process can ask for a random number—sequence number pair without paying for the ticket or only pay if the random has probability of winning higher than even distribution.

### Example 3

Different Types of Games

Objectives

The games in a gaming platform can be very different from one another. Most of the difference is screened by the game servers. The main difference, which affects the Instant Platform is when some games need only one hit to the server to decide the outcome while others need many.

The BwInstantService allows several types of Instant transactions. The instant transactions are not all the same and depending on their type different fields will be filled. The following example discloses 5 different types of Instant Transactions possible.

Type A—No Random

This particular type of instant transaction is created without any connection to a Black Box. So no true random number is involved. This solution is used in the following:
the second or third step in a multi-step game where the play data was determined by step one
a game using software random only (promotional games for example)
a game where no random number is needed (Chess etc)

With this type the Game server will call the BGP with a Instant transaction with all the required information, it will be stored in the database adding only ID and created date.

Type B—Random Only, No Prize Table

This type of instant transaction does not use a prize table. A random number is requested from the Black Box and stored in a Instant transaction. This solution is used for example as a first step in a multi step game, where the prize category is not decided until the last step. F. ex Black Jack creates one Instant Transaction of this type per call to the server, while requesting new cards. The last step will then determine the prize category.

Type C—Static Database Prize Table

This particular type of instant transaction stores the prize table in the Database. Therefore, the Black Box returns a random number, which is used to decide on the prize category. The prize table is static, meaning that the odds do not change as users play. For example if there are 50 winners and 200 non winners in the prize table there will still be 50/200 after someone has played

A suggested table structure for Type C is as follows:

```
-- This table holds the definition of a static pool,
-- the odds do not change when played
CREATE TABLE bgpInstantStaticPool (
  casinoId varchar2 (16) NOT NULL ,
  gameId varchar2 (16) NOT NULL ,
  draw varchar2 (16) NOT NULL ,
  prizeCategory int NOT NULL ,
  prizeAmount double NOT NULL ,
  shares number(18, 0) NULL ,
  description varchar2 (256)
)
/
```

### Example Values

| | | | | | | DE- |
|---|---|---|---|---|---|---|
| | | | | | | SCRIP- |
| CAS | GAMEID | DRAW | PRIZCAT | PRIZE | SHARES | TION |
| BW | SLOT | 003 | 1 | 10000 | 3 | Gold |
| | | | | | | coffins |
| BW | SLOT | 003 | 2 | 500 | 10 | Silver |
| | | | | | | coffins |
| BW | SLOT | 003 | 3 | 200 | 100 | . . . |
| BW | SLOT | 003 | 4 | 100 | 300 | . . . |
| BW | SLOT | 003 | 5 | 50 | 500 | |
| BW | SLOT | 003 | 6 | 30 | 2000 | |
| BW | SLOT | 003 | 7 | 25 | 40000 | |
| BW | SLOT | 003 | 8 | 10 | 200000 | |
| BW | SLOT | 003 | 9 | 5 | 500000 | |
| BW | SLOT | 003 | 10 | 0 | 3000000 | |

Type D—Dynamic Database Prize Table

A suggested Table structure for this solution is as follows:

```
-- This table holds the definition of a dynamic pool, the odds change as
playing goes on
-- The purpose of the two additional fields is to count what has been
played
CREATE TABLE bgpInstantDynamicPool (
  casinoId varchar2 (16) NOT NULL ,
  gameId varchar2 (16) NOT NULL ,
  draw varchar2 (16) NOT NULL ,
  prizeCategory int NOT NULL ,
  prizeAmount double NOT NULL ,
  shares number(18, 0) NULL ,
  description varchar2 (256),
  totalSharesPlayed number(18, 0) NULL ,
  sharesLeft number(18, 0) NULL
```

This solution allows for refilling the pool automatically, where examples of the reload rules are such as:
No first price
Less than certain percentage of pool tickets left

Type E—Black Box Prize Table

This type of instant transaction gets the prize category decided by the Black Box, so the prize table is stored there and not as a prize table in the database.

Conclusions

Single Step

Single step game means that only one server hit is made from the player, that step decides the final outcome of the game and is stored in the Betware database along with the possible prize before returning the result to the player.

In this type only one Instant transaction is made containing both the price and the prize info.

The random number created in the Black Box and stored in the Black Box or Evidence database together with a transaction log can be used to recreate the ticket and use it as a base for auditability.

Multi Step

A multi step game is a game where the server gets more than one hit from the user to conclude the game. Examples of such games are BlackJack and Poker where the player first gets the initial hand, then makes some decision and the server needs to act based on that decision (like split in BlackJack).

The first step in such a game would usually be of type B,C or D where some random factor is needed. The following steps might be of type A where no new random factor is needed into the play.

However if BlackJack is the example it might propose a threat to decide layout of the next 10 cards (all you will need till end) based on the first random and store it in memory while the player makes his choices. The threat is if someone can on the server side see the first random and knows the formula to calculate the 10 cards from there, he will have a significant advantage in the game. Therefor it is best for multistep games to request a new random and reshuffle the rest of the cards based on that one.

### Example 4

The following protocol discloses the purpose of the BwInstantService in:
1. Recording and selecting back all instant transactions that occur in the system
2. Handling communications with the Black Box.
3. Selecting instant prize categories when the pool definition is stored in the database

Instant transactions are very important in the auditing process, they contain all returned values from the Black Box, and the purpose is being able to audit all tickets created in the gaming system by use of return values from the Black Box. A Black Box is never called (except in the auditing process) without making an instant transaction.

Following is a suggestion of the instant transaction table, with some explanations. A corresponding BwInstantTransaction object will be created.

```
-- In this transaction table, for each play, one row is added to this table
-- with the blackbox sequence and random values as well as the resulting
prizeCategory and prize.
Only fields relevent to the auditing are shown.
CREATE TABLE bgpInstantTransactions (
  instantTransactionId number(18, 0) NOT NULL , -- unique ID
-- Standard game fields
  casinoId varchar2 (16) NOT NULL ,
  gameId varchar2 (16) NOT NULL ,
  draw varchar2 (16) NOT NULL ,
-- Randoms from the Black Box and prize category calculated from it
  blackSequence number(18, 0) NULL ,
  blackRandom number(18, 0) NULL
  prizeCategory int NOT NULL ,
  prizeAmount double NOT NULL ,
  price number NOT NULL ,
  stepSequence int NOT NULL , -- if more than one step is required within
  the same play
  flags int NOT NULL ,
  xmlData varchar2 (4000) NULL
)
/
```

### Example 5

The following example makes reference to the 5 different types of Instant Transactions (A-E) listed in Example 3.

i) Altering the Prize Table

For the solutions where the prize table is stored in the database (C, D), the database administrator could change the prize table to make all categories big prize and no non-winners. Then he would play, win big, and change the prize table back to the previous state.

ii) Ignoring the Prize Table

Malicious code working with prize table in the database (type C,D) could ignore the prize table and register a instant transaction as a win no matter what the random number.

Solution

This is audited by Auditing Instant Transactions vs. Certified Prize Table and this process needs only run for type C and D instant transactions, where the prize table is stored in the database. The Auditor provides a prize table that is known to be the correct one, a Certified Prize Table, and for each instant transaction the prize category and prize amount is recalculated from the evidence random number created for the instant transaction. The audit process gets lists from the Black Box/Evidence database and Gaming System and compares/audits the Gaming System Transaction against the evidence data.

The auditing process basically goes through all transactions form the gaming system database and recalculates the prize category compared to the certified prize table by using the random number from the Black Box. The results from the auditing are then reported once the auditing process has been performed. The audit process could be run by auditor manually or be configured to run automatically on intervals.

iii) Changing Customer-Id of Winner

For all types of Instant transactions (A-E), the database administrator could find a big winner and change the customer-Id of that instant transaction to his own and also the connected account transaction and adjust the balance of both accounts to make everything look as he had won the instant game.

iv) Monitoring Dynamic Prize Pools

For solution having a dynamic prize pool in the database (D), the database administrator could monitor the size of the prize pool and type of prizes left, such a situation can come up that it pays to buy the rest of the pool since one or more big prizes are left, and their value is bigger than the price for the rest of the pool.

The best way to audit this is to make sure this situation does not arise. This can be ensured by refilling the prize pool under certain conditions, automatically or raise an alert (to more than one person), so that it can be performed manually.

If for some reason the lottery chooses to finish the table, and not refill, this threat exists unless viewing of the table is restricted in some way, for example field/table encryption.

An audit process could be created to spot if Instant transactions are being created too rapidly (less than 5 sec between two transactions for the same customer) or abnormally many by the same customer.

v) Changing Type A Transactions

For multi-step games the first transaction often is of type B,C, D or E where board of the game is decided, for example shuffling the card deck. The next steps are often type A where user interactions are being logged with their consequences. A Database administrator could afterwards change his decision during the game, for example throw one instead of three cards in poker.

Solution

This is audited by Comparing Instant Transactions vs. Evidence Database. Since all instant transactions are written to Evidence database at creation time as a part of a database transaction, it is secured that if anything gets changed in the after math by a Database Administrator it will be trace-able. This audit process will take all instant transactions in the Betware Database and compare them field by field to the ones in the evidence database.

Auditing against the Evidence Database basically goes through all transactions form the database and compares the transactions to a list of all transactions from the Evidence Database. The results from the auditing are then reported once the auditing process has been performed.

vi) Faking the Random Number

The random number from the Black Box could be tampered with (B, C,D type transactions) and changed to a number resulting in a prize or the prize category changed (type E transactions). This could be done either by connecting into the line running from the Black Box to the appserver or by-hacking the appserver, either the communications or alter the code running there.

vii) Skipping Random Numbers Until Prize

To make sure the random number exist in the Black Box malicious code could call the Black Box without registering instant transactions until it gets a random number resulting in a prize (type B,C,D) or a good prize Category (type E), then the instant transaction is registered with a valid reference to the Black Box.

viii) Changing Customer Id of Winner

Bad code could for all types wait for big winners and at that time change the customer Id to take the prize. This would be done before it is registered in the database and is therefore not trace-able by the evidence database.

Solution

This is audited by Auditing Instant Transactions vs. Black Box

Getting the list from the Black Box must be done through secure and certified channels to prevent tampering.

Details

Every instant transaction made in the Betware database for type B,C,D,E transactions will be compared against the random numbers given by the Black Box. Type A transactions do not communicate with the Black Box and are no concern therefore.

Serial number, random number, customer-Id and game-Id must match for type B,C,D transactions.

Prize category and prize Amount must match additionally for type E transactions since they come from the Black Box.

The following transactions will be reported after the auditing process, which may be run nightly:

I. Do Not Match Between the Systems

Reason
This mismatch would indicate a definite cheat or a software bug since the serial number exists in both places but the random number, customer-Id or game-Id (or prize Category/prize Amount for type E) does not match.

Auditor Action
Analyse
   Administrator access
   Journaling logs
   Hackers
   New deployments
   Betware logs
   Make necessary arrangements

II. Exist in the Betware Database but not in Black Box

Reason
This mismatch would indicate a definite cheat or a software bug since no serial number should exist in Betware database without being originated from the Black Box.

Auditor Action
Analyse
   Administrator access
   Journaling logs
   Hackers
   New deployments
   Betware logs
   Make necessary arrangements

III. Exist in Black Box but not in the Betware database

Reason
This mismatch could be caused by operational failures, network errors etc but should be rare. After the Betware system calls the Black Box, registers a random number and returns it, anything can go wrong that causes the Betware system not to get the number, in that case either a new number is requested or the whole transaction is rolled back in the Betware system.

Auditor Action
Analyse Betware logs to see if some network or system error caused a problem
New deployments
Hackers
Access groups
Make necessary arrangements

### Example 6

Auditing

The auditing system is designed to audit different types of wagers/tickets. The principle behind the Auditing System is to have evidence of the game data in a certified Auditing System before the result is known to the user or any operator or system part of Betware Solutions. The Auditing System is physically only accessible to the auditing staff that does not have access to Betware System.

The evidence can originate from different sources and an example of evidence is wagers before result is known (before events start for sports wagering and before result is drawn for number games) and certified random numbers linked with customer-Id and sequence number (instant tickets).

At any given time an auditor can compare the wagering/tickets in Betware database with the evidence residing in the Evidence Database and Black Box. The auditing process is capable of finding all instances of threads, thus making it possible to trace illegal actions taken by operator staff (lottery), supplier staff (Betware) or hackers (outsiders) so long the certified Auditing System is not accessible by others than trusted auditors.

FIG. 4 shows how a certifying zone can be arranged comprising:
a black box
evidence database
audit processing means

The black box generates information for a ticket to the Betware system, which is stored in the Betware database. This information is also stored in the evidence database and the audit processing means uses several auditing processes to audit data in the gaming system against the evidence database and Black Box.

Auditing Wagers in Pools Games

Wagers in pool games are not discussed in any more detail in this BSR but their auditing is closely related to the instant auditing. Wagers are transferred to the Evidence Database at the time of wagering, thus being able to manage quick draw auditing without special time consuming processing after a draw is closed. There is of course no Black Box involved here.

The audit processes run on a separate machine that only the auditors have access to. The processes can be automated in such a way that they know, where they are at in the data (what day, last serial number etc) or this info could be entered by the auditor at start of a manual process.

It is important that information concerning what has been audited and what not must come from the auditing machine and not be stored somewhere else. Therefore, records in the Betware system and the Black Box cannot be marked in any way after auditing.

### Example 7

An overview of the Instant buy process.

The instant game runs on a client console, typically written in flash. This step might have logic written into it, since it must make display decisions based on user input and not making server calls unless necessary.

The next step, the Instant Game Action, which is in generic code, is mainly responsible for passing data back and forth between games and game servers and controlling the session data. The action should have some configuration like casino-Id, game-Id, instant transaction type, user type that is allowed to play etc. and be a gate or a filter in that sense. Furthermore this set-up defines the type of instants being played and creates the Bwinstant transaction objects.

The instant game server contains game logic to decide, given the prize category from the lower components, what actions the game should take, by looking up in reference tables or by making software (sudo) random decisions. Using software random (java rand) at this point to decide on what the user gets displayed is not of huge importance since it is being decided within the given prize category. The prize category and amount will always be decided by the lower secure parts of the system. When a decision has been made on which game is being played the instant game server calls the BwSaleManager.

The following three components are all apart of the Betware Gaming Platform (BGP):
The BwSaleManager, which handles the transaction.
BwAccountService, which handles charging of accounts and stores them in the BGP database.
BwInstantService, which handles the communication to the Black Box through a BGPExtension and stores all Black Box transactions into the Database along with other game specific data from the Game Servers. This service also handles instant prize tables when they are required to be stored and manipulated in our system.

The BwInstantServiceExtension demands a service out of the Black Box directly or some kind of Legacy connector handling queues and multithreading for the Black Box.

The Black Box is a physically secured box with a predefined and limited task of returning random numbers or prize categories in implementations that wish to move prize tables to the Black Box.

The Evidence database is a database (or schema for Oracle), which is different from the BGP database. Very limited access is provided to this database and a different database administrator is assigned to the evidence database than to the BGP database. All BwInstantTransactions (and coupons) are written there upon request to have a copy of the transaction that cannot be altered by the BGP database administrator. The Evidence Database also differs in that it only allows insert of records and then viewing, no changes are allowed to the data in the Evidence Database.

### BRIEF DESCRIPTION OF THE DRAWINGS

The present invention will now be described in more detail by means of the accompanying drawings in which:

FIG. 1 shows a block diagram describing how speed is generated in an on-line system according to the present invention,

FIG. 2 shows a block diagram describing the overall audit process of an on-line system according to the present invention, and

FIG. 3 shows the features of the audit process of FIG. 2.

### DETAILED DESCRIPTION OF THE DRAWINGS

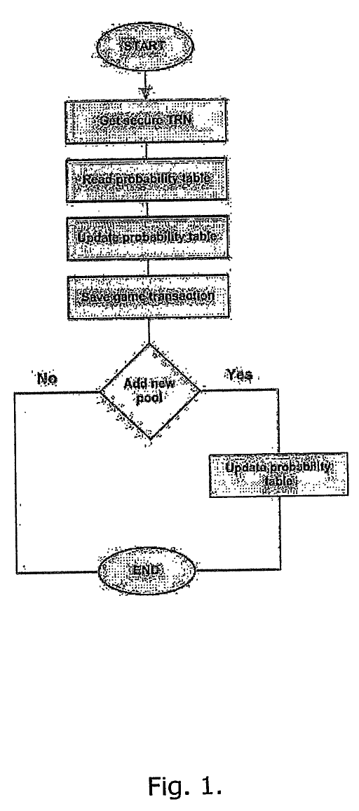

FIG. 1 describes the method of generating speed in a ticket lottery and how one or several pools are managed during a lottery game. The process of the method is initiated by a request from a customer. The customer accesses an instant lottery game through the Internet, by placing an electronic request using, e.g., a PC compatible client or an embedded POS Lottery device. The request is directed to the Betware Gaming Platform (BGP), comprising a processing means including a probability table and storage means. The probability table represents the current game and resembles unsold tickets in all existing pools of the game. The BGP handles the request by charging the customer for the ticket and when the BGP has received a confirmation that a payment has been made the BGP requests a true random number (TRN). Based on the current instant pool (i.e. the probability table) and the random number, the BGP calculates the category the ticket belongs to. The instant pool is changed after generation of each ticket according to the category (one less in that particular category), by updating the probability table. The game transaction, including a sequence number and the category to which the ticket belongs to, is saved by the BGP. The platform is thereafter ready to service the next customer.

Based on criteria set by the Lottery, a minimal number of tickets in the lottery or in each category are allowed. If these criteria are not met, a new pool or category may be added into the lottery. If a new pool or category is added into the lottery,.the probability table is updated, and the platform is thereafter ready to service the next customer.

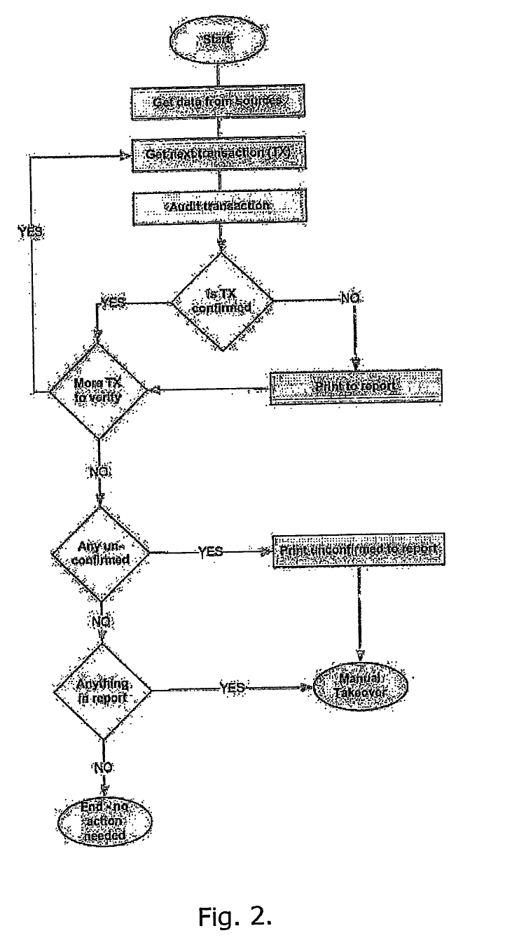

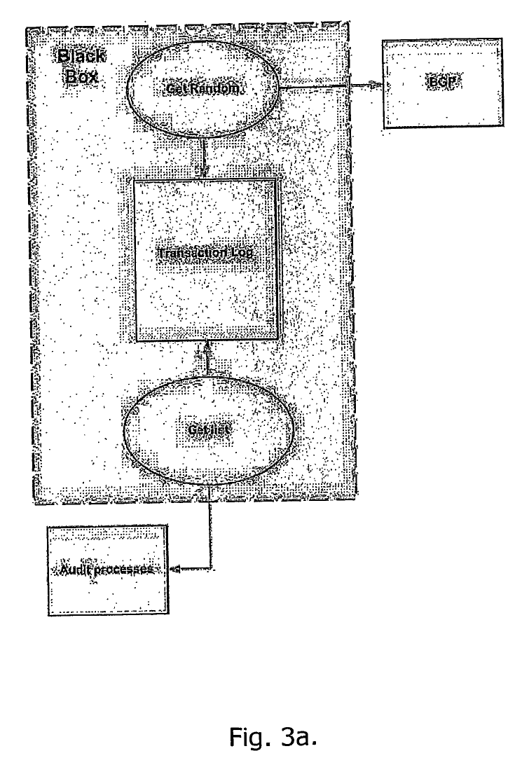

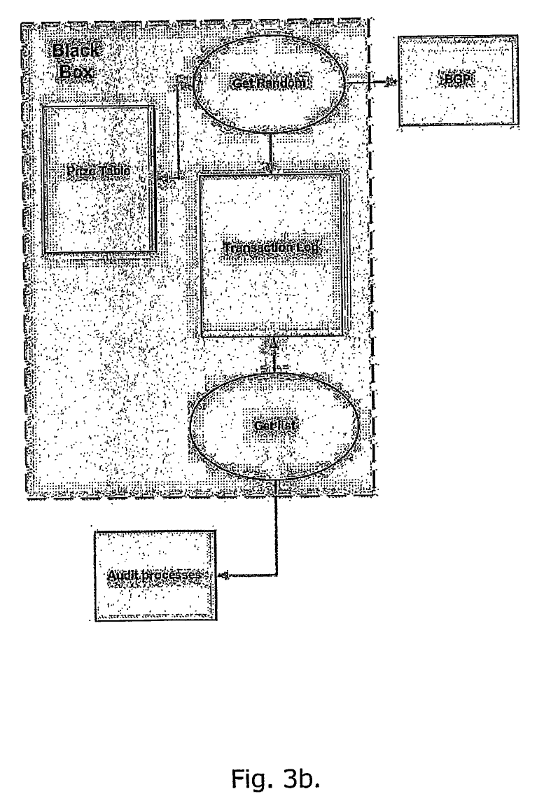

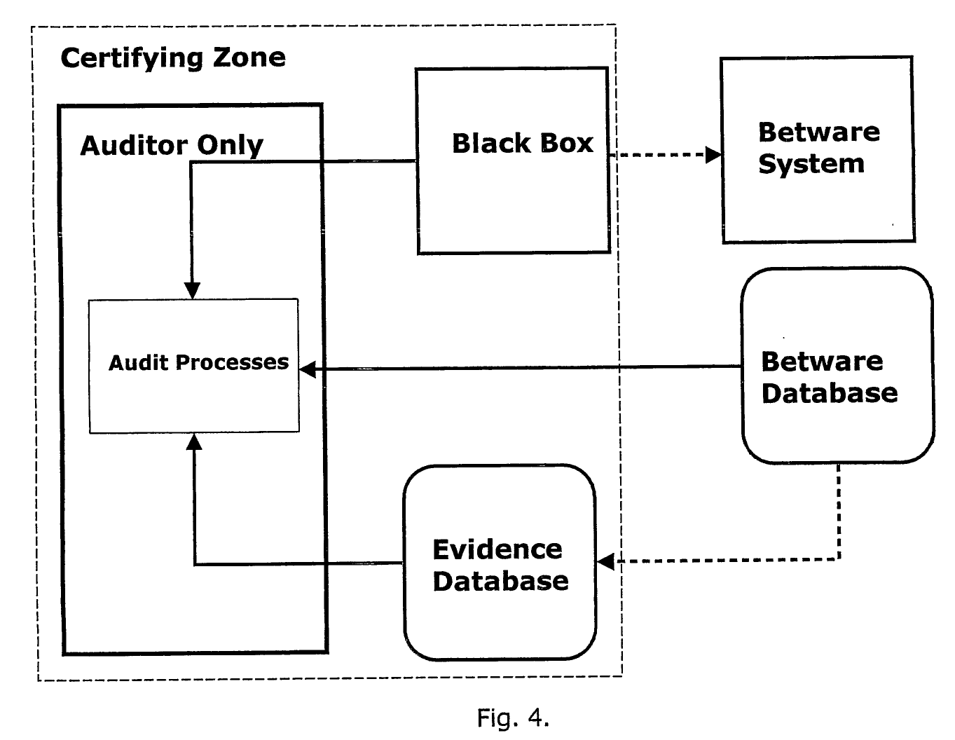

FIG. 2 describes the overall audit process offered by the system. The process is initiated by selecting a sequence range, which covers all sequence numbers issued from the last time of auditing and to the time of present auditing. The process verifies each pair stored in a “black box” of the system and compares them to all pairs stored in the Betware Gaming Platform (BGP). This process is described in detail in FIG. 3. If the pair is confirmed the BGP marks the pair as confirmed and starts verifying the next pair, provided that there are more pairs stored in the BGP. However, if the pair is not confirmed a report is printed alerting the administrators/auditors, and appropriate actions are taken. This basically results in manual take over (described in FIG. 4).

If there are no more pairs in the BGP, the audit process gets unconfirmed pairs, a process described in more detail in FIG. 3. If there are no unconfirmed pairs in the system the audit process asks if a certain pool should be closed. Based on the current status of the pool, e.g. if all the tickets in the pool have been sold, the pool is closed. If unconfirmed pairs exist in the “black box”, but not in the BGP, the audit process prints a report alerting the administrators/auditors and appropriate actions are taken.

FIG. 3 shows the different components of the “Black Box”. The Black Box is a standard PC computer running an operating system such as DOS or Linux and is running very specialized program (and nothing else). Preferably the Black Box comprises nothing it does not have to use.

All numbers the Black Box returns are written to a local file along with a timestamp. This file is later used for auditing. Physical security of the Black Box is very important, possibly protocols should be invented where at least two people have to be present when it is accessed.

The standard implementation of the Black Box shown in FIG. 3.a, has 3 different methods:
Get random
Get list
Keeping a transaction log

The “get random” function is used in the buy process, whereas the “get list” function is used in the auditing process.

The standard implementation of a Black Box is during buy process only to return serial number and a random number to the BGP. The serial number is for auditing purposes and will be stored with the BwInstantTransaction in the database. The random number is used to determine the prize category the user gets (non-winner being a prize category as well).

The Transaction log comprises the following for each request:
The gameId is sent into the Black Box so that different games can have different ranges of random numbers. A certain game has for example a random number in the range of 1 to 4.000.000 while another has one to 2 billions.
The customerId is important for the auditing purposes. It provides a record on who the customer is that is getting this particular random number, since bad code outside the black box (in a not as certified and protected area) could else “steal” the prize. Therefore the solution is to store the customerId in the Black Box and then the code is certified, so it can be made sure that no harmful code is there.
A timestamp is useful when tracing a problem or a security breach. Although the Black Box should be as simple as possible, the same applies to the timestamp-as to the customerId, that is this code will be certified.
The Sequence number “from”. As the auditing process is not starting from the very beginning every time it does auditing, it only needs a list from some specific point. All records created after the “from” sequence number should be returned in the GetList method.
The Get list function fetches all rows higher than the given sequence number and returns that list to the evidence database.

The more complex version of the Black Box is shown in FIG. 3.b, which is implemented with Prize Table

It is an option to store the prize table on the Black Box. In this particular application, the prize table is no longer kept in the database but only in the Black Box. The BB starts by generating sequence number and random number the standard way and uses it internally to look up the prize in the prize table, using the same principles as are used when the prize table is on the BGP (database) side. Sequence number and random number, along with prize category and prize amount are then returned to the BGP.

In an embodiment of the present invention, the network protocol of the BB is serial communication.

FIG. 4 demonstrates the auditing process and the components involved in the auditing. A certifying zone comprises a black box, auditing means and an evidence database. The figure is referred to and supports the subject matter in example 6.

1-61. (canceled)

62. A method of obtaining security and audit ability in an on-line system, the method comprising the steps of:
generating a random number by means of a random number generator,
providing a sequence number for each of the random numbers generated so as to create a random number—sequence number pair,
storing the created random number—sequence number pair in a storage means, the method further comprising the step of, at a chosen time, verifying stored random number—sequence number pairs, so as to ensure that every stored random number—sequence number pair is an authentic random number—sequence number pair.

63. A method according to claim 62, wherein the storing step is performed by storing the random number—sequence number pair in a storage means with limited access.

64. A method according to claim 62, wherein access to the limited access area(s) can only be obtained by one or more authorised persons.

65. A method according to claim 62, wherein the limited access area further generates a transaction log comprising:
a timestamp,
a game-id,
a customer-id,
a sequence number, and
a random number,
wherein the transaction log is stored in a second limited access area.

66. A method according to claim 62, wherein the limited access area further comprises a prize table.

67. A method according to claim 62, wherein the transaction log is used to audit transactions in an online system by one or more audit processes performed by audit processing means.

68. A method according to claim 62, further comprising the step of issuing a ticket comprising information relating to the sequence number.

69. A method according to claim 68, wherein the on-line system is a lottery, and the issued ticket is a lottery ticket.

70. A method according to claim 69, wherein the ticket further comprises information relating to a winning/no winning category of the ticket.

71. A method according to claim 69, wherein the step of issuing a ticket is based upon the random number and a probability table, the method further comprising the step of updating the probability table in response to the issued ticket, so as to maintain an at least substantially fixed winning/no winning ratio.

72. A method according to claim 62, wherein the on-line system is an encryption system.

73. A method according to claim 62, further comprising the step of alerting an operator in case the verifying step results in the discovery of one or more non-authentic random number—sequence number pairs.

74. A method according to claim 62, wherein the verifying step comprises the steps of:
checking whether a given random number—sequence number pair has previously been stored in the storage means,
marking said given random number—sequence number pair as a true pair in case it has previously been stored in the storage means, and
alerting an operator in case the given random number—sequence number pair has not previously been stored in the storage means.

75. A secure and auditable on-line system comprising:
a random number generator,
means for providing a sequence number for each generated random number, so as to create a random number—sequence number pair,
storage means for storing the created random number—sequence number pair,
verifying means for verifying, at a chosen time, stored random number—sequence number pairs against a transaction created in the online system, so as to ensure that every stored random number—sequence number pair is an authentic random number—sequence number pair.

76. An on-line system according to claim 75, wherein the storage means has limited access.

77. An on-line system according to claim 75, wherein access to the limited access area(s) can only be obtained by one or more authorised persons.

78. An on-line system according to claim 75, wherein the first storage means further comprises means for generating a transaction log and a get list.

79. An on-line system according to claim 75, wherein the transaction log is stored in a second storage means.

80. An on-line system according to claim 75, wherein the data stored in the first storage means is used to audit transactions in a online system by an audit processing means.

81. An on-line system according to claim 75, wherein the data stored in the second storage means can be used to audit transactions in a online system by an audit processing means.

82. An on-line system according to claim 75, wherein the first storage means, second storage means and the audit processing means are concealed in a certification zone.

83. An on-line system according to claim 75, further comprising means for issuing a ticket comprising information relating to the sequence number.

84. An on-line system according to claim 83, wherein the on-line system is a lottery, and the issued ticket is a lottery ticket.

85. An on-line system according to claim 83, wherein the ticket is issued based upon the random number and a probability table, the on-line system further comprising means for updating the probability table in response to the issued ticket, so as to maintain an at least substantially fixed winning/no winning ratio.

86. An on-line system according to claim 75, wherein the on-line system is an encryption system.

87. An on-line system according to claim 75, further comprising means for alerting an operator and an auditor in case the verification results in the discovery of one or more non-authentic random number—sequence number pairs.

88. An on-line system according to claim 75, wherein the verifying means further comprises:
means for checking whether a given random number—sequence number pair has previously been stored in the storage means,
means for marking said given random number—sequence number pair as a true pair in case it has previously been stored in the storage means, and
means for alerting an operator in case the given random number—sequence number pair has not previously been stored in the storage means.

89. A device for providing security and audit ability in an on-line system, the device comprising:
a random number generator,
means for providing a sequence number for each generated random number, so as to create a random number—sequence number pair,
storage means for storing the created random number—sequence number pair,
verifying means for verifying, at a chosen time, stored random number—sequence number pairs against a transaction created in the online system, so as to ensure that every stored random number—sequence number pair is an authentic random number—sequence number pair,
the verifying means further comprising:
means for checking whether a given random number—sequence number pair has previously been stored in the storage means,
means for marking said given random number—sequence number pair in the online system as a true pair in case it has previously been verified against the random number—sequence number pair in the evidence storage means.
means for alerting an operator in case the given random number—sequence number pair has not previously been verified,
wherein the storage means and the random number generator have limited access.

90. A computer program product for obtaining security and audit ability in an on-line system, the program being adapted to:
generate a random number by means of a random number generator,
provide a sequence number for each of the random numbers generated so as to create a random number—sequence number pair,
store the created random number—sequence number pair in a first storage means,
the program further being adapted to verify stored random number—sequence number pairs, so as to ensure that every stored random number—sequence number pair is an authentic random number—sequence number pair.

91. The computer program product of claim 90, wherein a transaction log is generated, the transaction log comprising:
a timestamp,
a game-id,
a customer-id,
a sequence number, and
a random number,
herein the transaction log is stored in a second storage means.

92. The computer program product of claim 90, wherein the online generated information in a first storage means and a second storage means is used to audit transactions in the online system by one or more audit processes performed by an audit processing means.
